(19) United States
(12) Patent Application Publication
(10) Pub. No.: US 2011/0285955 A1
(43) Pub. Date: Nov. 24, 2011

(54) DISPLAY DEVICE AND METHOD FOR MANUFACTURING DISPLAY DEVICE

(75) Inventor: Koichi Nagasawa, Aichi (JP)

(73) Assignee: SONY CORPORATION, Tokyo (JP)

(21) Appl. No.: 13/089,585

(22) Filed: Apr. 19, 2011

(30) Foreign Application Priority Data
May 21, 2010 (JP) 2010-116916

(51) Int. Cl. G02F 1/1333

(52) U.S. Cl. 349/158; 349/187

(57) ABSTRACT

Disclosed herein is a display device including a first transparent substrate configured to have a surface including a display area and a peripheral area that surrounds the display area and includes an interconnect pattern forming area and an interconnect pattern non-forming area, an interconnect pattern configured to be formed above the interconnect pattern forming area and have light blocking capability, a structural body configured to be formed above the peripheral area in such a manner as to expose the interconnect pattern non-forming area and cover the interconnect pattern, a seal material configured to be formed above the peripheral area in such a manner as to cover the interconnect pattern non-forming area and surround the structural body, a display layer configured to be formed above the display area, and a second transparent substrate configured to be formed over the structural body, the seal material, and the display layer.

### BACKGROUND OF THE INVENTION

1. Field of the Invention

The present invention relates to display devices and methods for manufacturing a display device. Specifically, the invention relates to a display device having two transparent substrates opposed to each other and a display layer formed between two transparent substrates, and a method for manufacturing a display device.

2. Description of the Related Art

There exists a display device having two transparent substrates opposed to each other and a display layer formed between two transparent substrates. Examples of such a display device include a liquid crystal display device having an array substrate obtained by forming plural transistors such as thin film transistors (TFT) in an array manner over a transparent substrate, a color filter substrate obtained by forming a color filter over a transparent substrate, and a liquid crystal layer formed between the array substrate and the color filter substrate.

In the liquid crystal display device, a seal material is formed in the peripheral area of the array substrate and the color filter substrate in order to bond the array substrate and the color filter substrate to each other. After the array substrate and the color filter substrate are bonded to each other by the seal material, the seal material is irradiated with ultraviolet (UV) light to be cured.

There also exists a liquid crystal display device in which for example a seal material is so disposed as to overlap with a black resist formed in the peripheral area of the color filter substrate in order to reduce the size of the liquid crystal display device. In such a liquid crystal display device, because the black resist has light blocking capability, irradiation of the seal material with UV light can not be performed from the color filter substrate side and has to be performed from the array substrate side.

In such a liquid crystal display device in which irradiation with UV light is performed from the array substrate side, a peripheral circuit pattern formed in the peripheral area of the array substrate blocks the UV light. Therefore, possibly the seal material located in an area overlapping with the peripheral circuit pattern is not sufficiently irradiated with the UV light and remains an uncured state. In this case, possibly the uncured seal material elutes into the liquid crystal layer and displaying defects such as spots and burn-in occur.

As a technique to address this problem, there is proposed a technique in which array interconnects continuously provided over the array substrate from the liquid crystal layer side toward the outside of a seal member are formed in a slit manner to thereby allow the UV seal to be sufficiently irradiated with UV light and prevent the elution of the UV seal into the liquid crystal layer (refer to e.g. Japanese Patent Laid-open No. 2007-233029).

### SUMMARY OF THE INVENTION

However, the method of forming the array interconnects in the slit manner involves the possibility that the flexibility of the design of the array interconnects is significantly limited. Such a problem possibly occurs similarly also in other display devices having two transparent substrates opposed to each other and a display layer formed between two transparent substrates, e.g. an organic electro luminescence (EL) display device in which an organic EL film is formed between two transparent substrates.

There is a desire for the present invention to provide a display device having enhanced display quality with maintenance of the flexibility of the design of interconnects formed over a transparent substrate, and a method for manufacturing a display device.

According to embodiments of the present invention, there are provided the following display device and method for manufacturing a display device.

The display device includes a first transparent substrate configured to have a surface including a display area and a peripheral area that surrounds the display area and includes an interconnect pattern forming area and an interconnect pattern non-forming area, an interconnect pattern configured to be formed above the interconnect pattern forming area and have light blocking capability, and a structural body configured to be formed above the peripheral area in such a manner as to expose the interconnect pattern non-forming area and cover the interconnect pattern. Furthermore, the display device also includes a seal material configured to be formed above the peripheral area in such a manner as to cover the interconnect pattern non-forming area and surround the structural body, a display layer configured to be formed above the display area, and a second transparent substrate configured to be formed over the structural body, the seal material, and the display layer.

The method for manufacturing a display device includes the step of forming a positive photoresist layer over a surface side of a first transparent substrate that has a surface including a display area and a peripheral area surrounding the display area. An interconnect pattern having light blocking capability is formed above the peripheral area, and the positive photoresist layer covers the peripheral area. Furthermore, the method also includes the steps of irradiating the first transparent substrate over which the positive photoresist layer is formed with light from a back surface side and exposing the positive photoresist layer by use of the interconnect pattern as a mask, and forming a structural body by developing the exposed positive photoresist layer and selectively leaving the positive photoresist layer located above the interconnect pattern. In addition, the method also includes the steps of forming a seal material surrounding the structural body above the peripheral area of the first transparent substrate over which the structural body is formed, forming a stacked body obtained by stacking a second transparent substrate over the surface of the first transparent substrate with the intermediary of the structural body and the seal material, and irradiating the stacked body with light from the back surface side of the first transparent substrate and curing the seal material.

The display device and the method for manufacturing a display device according to the embodiments of the present invention allow enhancement in the display quality with maintenance of the flexibility of the design of interconnects formed over a transparent substrate.

### BRIEF DESCRIPTION OF THE DRAWINGS

FIG. 1 is a sectional view showing one example of a display device according to a first embodiment;

FIG. 2 is a sectional view showing one example of a liquid crystal display device according to a second embodiment;

FIG. 3 is a plan view showing one example of the liquid crystal display device according to the second embodiment;

FIGS. 4A and 4B are enlarged plan views of FIG. 3;

FIG. 5 is a sectional view showing a modification example of the liquid crystal display device according to the second embodiment;

FIG. 6 is a flowchart showing one example of a method for manufacturing a liquid crystal display device according to a third embodiment;

FIGS. 7A to 7J are step diagrams showing one example of the method for manufacturing a liquid crystal display device according to the third embodiment;

FIG. 8 is a sectional view showing one example of a liquid crystal display device according to a fourth embodiment;

FIG. 9 is a flowchart showing one example of a method for manufacturing a liquid crystal display device according to a fifth embodiment; and

FIGS. 10A to 10J are step diagrams showing one example of the method for manufacturing a liquid crystal display device according to the fifth embodiment

### DETAILED DESCRIPTION OF THE PREFERRED EMBODIMENTS

Embodiments of the present invention will be described below with reference to the drawings.

### First Embodiment

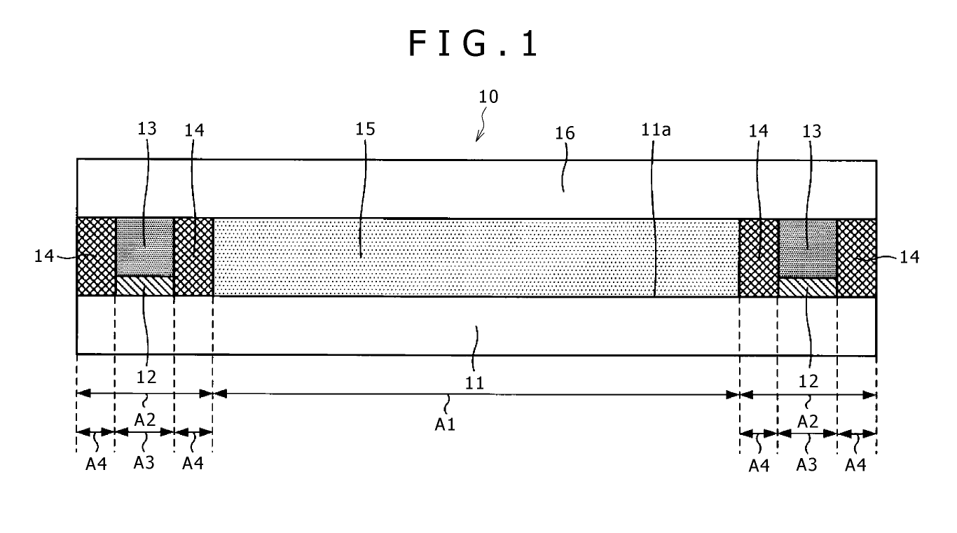

FIG. 1 is a sectional view showing one example of a display device according to a first embodiment of the present invention.

A display device 10 includes a transparent substrate 11 having a surface 11a including a display area A1 and a peripheral area A2 surrounding the display area A1. Furthermore, the peripheral area A2 includes an interconnect pattern forming area A3 and an interconnect pattern non-forming area A4.

An interconnect pattern 12 having light blocking capability is formed above the interconnect pattern forming area A3. Plural transistors (not shown) such as TFTs are formed in an array manner above the display area A1. The interconnect pattern 12 configures a peripheral circuit electrically connected to these transistors. Furthermore, plural transparent electrodes (not shown) are formed above the display area A1. Each of the plural transparent electrodes is electrically connected to a respective one of the transistors.

Above the peripheral area A2, a structural body 13 that exposes the interconnect pattern non-forming area A4 and covers the interconnect pattern 12 is formed.

Furthermore, above the peripheral area A2, a seal material 14 is formed in the same layer as that of the structural body 13 for example. The seal material has such photocurability as to be cured by UV light for example. The seal material 14 is so formed as to surround the structural body 13. That is, the seal material 14 is so formed as to expose the interconnect pattern 12 and cover the interconnect pattern non-forming area A4.

A display layer 15 is formed above the display area A1. As the display layer 15, e.g. a liquid crystal layer or an organic EL film is used.

Moreover, a transparent substrate 16 is formed over the structural body 13, the seal material 14, and the display layer 15. Over the transparent substrate 16, e.g. a color filter (not shown) and a transparent electrode (not shown) are formed. Therefore, the transparent substrate 16 is disposed opposed to the transparent substrate 11 with the intermediary of the structural body 13 and the seal material 14 packed around the structural body 13.

As just described, in the display device 10, the structural body 13 exposing the interconnect pattern non-forming area A4 and covering the interconnect pattern 12 is formed above the peripheral area A2, and the seal material 14 is so formed as to surround the structural body 13. That is, at the place shielded from the light for curing the seal material 14 by the interconnect pattern 12, the structural body 13 is formed and the seal material 14 is not formed. This can form the seal material 14 in a sufficiently-cured state and suppress the possibility of the elution of the seal material 14 into the display layer 15.

Furthermore, in the display device 10, the arrangement and shape of the interconnect pattern 12 do not have to be changed, and therefore the flexibility of the design of the interconnect pattern 12 is also not limited.

Next, an embodiment in which the display device 10 is applied to a liquid crystal display device will be described below as a second embodiment of the present invention.

### Second Embodiment

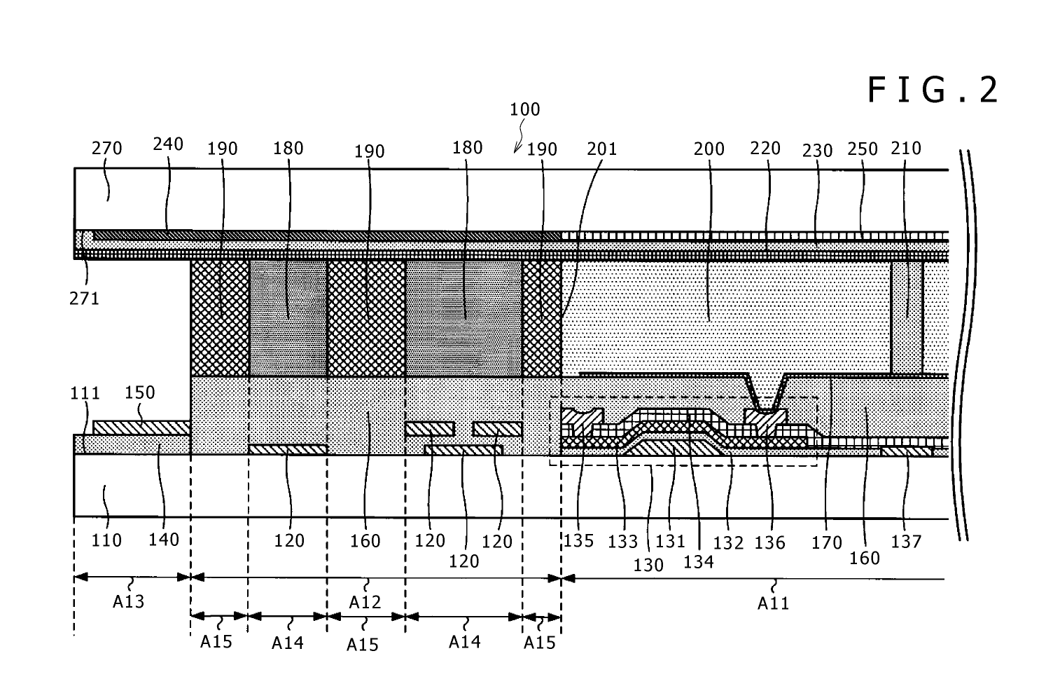

FIG. 2 is a sectional view showing one example of a liquid crystal display device according to the second embodiment.

A liquid crystal display device 100 includes a transparent substrate 110 having a surface 111 including a display area A11, a peripheral area A12 surrounding the display area A11, and a lead-out interconnect forming area A13 located outside the peripheral area A12. Furthermore, the peripheral area A12 includes an interconnect pattern forming area A14 and an interconnect pattern non-forming area A15. As the transparent substrate 110, e.g. a glass substrate is used.

An interconnect pattern 120 having light blocking capability is formed above the interconnect pattern forming area A14. As the interconnect pattern 120, e.g. a metal pattern is used. The interconnect pattern 120 configures a peripheral circuit and is formed as plural interconnect patterns for example. The plural interconnect patterns 120 are formed in multiple layers for example.

Plural transistors 130 such as TFTs are formed in an array manner above the display area A11. In the diagram, one transistor 130 as the representative is shown. The transistor 130 is electrically connected to the interconnect pattern 120. A light blocking pattern 137 is formed above a spacer forming area in the display area A11.

The transistor 130 has a gate electrode 131, a gate insulating film 132 covering the gate electrode 131, a semiconductor layer 133 formed over the gate insulating film 132, an interlayer insulating film 134 covering the semiconductor layer 133, and a source electrode 135 and a drain electrode 136 that are formed over the interlayer insulating film 134 and are electrically connected to the semiconductor layer 133.

Plural lead-out interconnects 150 are formed above the lead-out interconnect forming area A13 with the intermediary of an insulating film 140. The lead-out interconnect 150 is electrically connected to the interconnect pattern 120.

An insulating film 160 covering the interconnect pattern 120 and the transistor 130 is formed above the display area A11 and the peripheral area A12. The upper surface of the insulating film 160 is planarized. The insulating film 160 is so formed as to expose the lead-out interconnect 150.

A transparent electrode 170 is formed over the insulating film 160. As the transparent electrode 170, e.g. indium tin oxide (ITO) is used. The transparent electrode 170 is located above the display area A11. The transparent electrode 170 is electrically connected to the drain electrode 136 of the transistor 130, and voltage supply to the transparent electrode 170 is controlled by the transistor 130.

A structural body 180, a seal material 190, a liquid crystal layer 200, and a spacer 210 are formed over the insulating film 160. Above the peripheral area A12, the structural body 180 is so formed as to expose the interconnect pattern non-forming area A15 and cover the interconnect pattern 120. For the structural body 180, e.g. a resist material such as a resin is used.

The seal material 190 is formed above the peripheral area A12 in the same layer as that of the structural body 180 in such a manner as to surround the structural body 180. That is, the seal material 190 is so formed as to expose the interconnect pattern 120 and cover the interconnect pattern non-forming area A15. The seal material 190 has such photocurability as to be cured by UV light for example. As the material of the seal material 190, e.g. a material obtained by mixing a photo polymerization initiator into an acrylic/epoxy-based heat-curable resin is used.

The liquid crystal layer 200 is formed above the display area A11. A side surface 201 of the liquid crystal layer 200 is in contact with the seal material 190. The spacer 210 is formed above the light blocking pattern 137 and surrounded by the liquid crystal layer 200.

A transparent electrode 220 is formed over the structural body 180, the seal material 190, the liquid crystal layer 200, and the spacer 210. As the transparent electrode 220, e.g. ITO is used.

An overcoat layer 230 is formed over the structural body 180, the seal material 190, the liquid crystal layer 200, and the spacer 210 with the intermediary of the transparent electrode 220. A black resist 240 and a color filter (CF) 250 are formed over the overcoat layer 230.

The black resist 240 has light blocking capability. The black resist 240 is formed above the peripheral area A12 and the lead-out interconnect forming area A13. The color filter 250 is formed above the display area A11. The color filter 250 is formed of e.g. a resin film containing dyes or pigments having three primary colors of red (R), green (G), and blue (B).

A transparent substrate 270 is formed over the overcoat layer 230 with the intermediary of the black resist 240 and the color filter 250. The transparent substrate 270 has a surface 271 opposed to the surface 111 of the transparent substrate 110. As the transparent substrate 270, e.g. a glass substrate is used.

Next, the planar structure of the liquid crystal display device 100 will be described below.

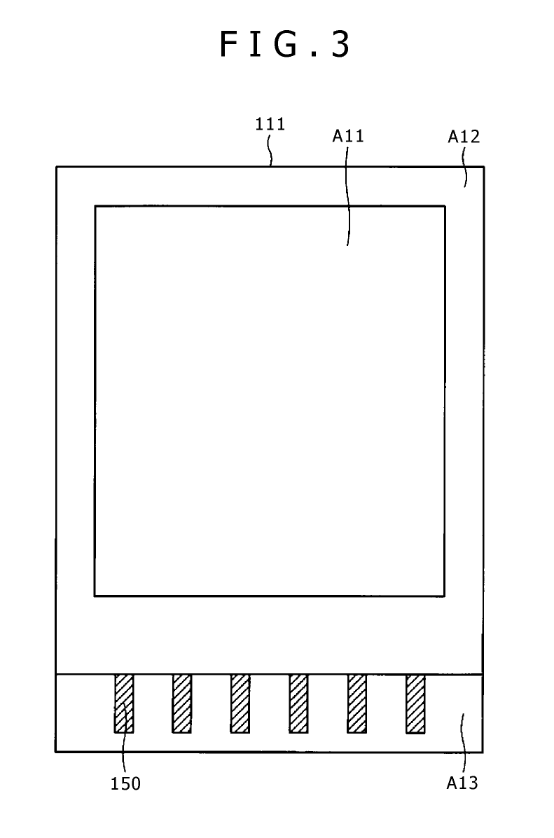

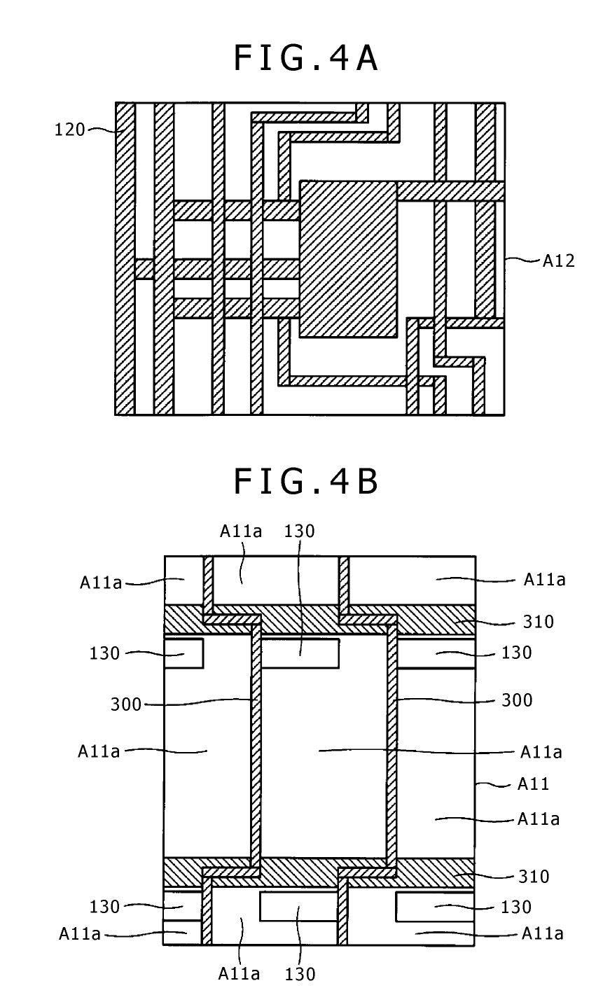

FIG. 3 is a plan view showing one example of the liquid crystal display device according to the second embodiment. FIGS. 4A and 4B are enlarged plan views of FIG. 3. In FIG. 3, diagrammatic representation of the configuration over the transparent substrate 110 except the lead-out interconnect 150 is omitted. In FIG. 4, diagrammatic representation of the insulating film 160 and the configuration over the insulating film 160 is omitted.

As shown in FIG. 3, the surface 111 of the transparent substrate 110 includes the display area A11 located at the center, the peripheral area A12 surrounding the display area A11, and the lead-out interconnect forming area A13 located outside the peripheral area A12. Above the lead-out interconnect forming area A13, the lead-out interconnect 150 is disposed.

As shown in FIG. 4A, the interconnect pattern 120 is disposed above the peripheral area A12. In this configuration, the plural interconnect patterns 120 with different widths are disposed. As shown in FIG. 4B, plural signal lines 300, plural gate lines 310, and the plural transistors 130 are disposed above the display area A11. The display area A11 includes plural pixel areas A11a surrounded by the signal lines 300 and the gate lines 310. The transistor 130 is disposed for each of the pixel areas A11a.

As just described, in the liquid crystal display device 100, the structural body 180 exposing the interconnect pattern non-forming area A15 and covering the interconnect pattern 120 is formed above the peripheral area A12, and the seal material 190 is so formed as to surround the structural body 180. That is, at the place shielded from the light for curing the seal material 190 by the interconnect pattern 120, the structural body 180 is formed and the seal material 190 is not formed. This can form the seal material 190 in a sufficiently-cured state and suppress the possibility of the elution of the seal material 190 into the liquid crystal layer 200.

Furthermore, in the liquid crystal display device 100, the arrangement and shape of the interconnect pattern 120 do not have to be changed, and therefore the flexibility of the design of the interconnect pattern 120 is also not limited.

Next, a modification example of the liquid crystal display device 100 will be described below.

### (Modification Example)

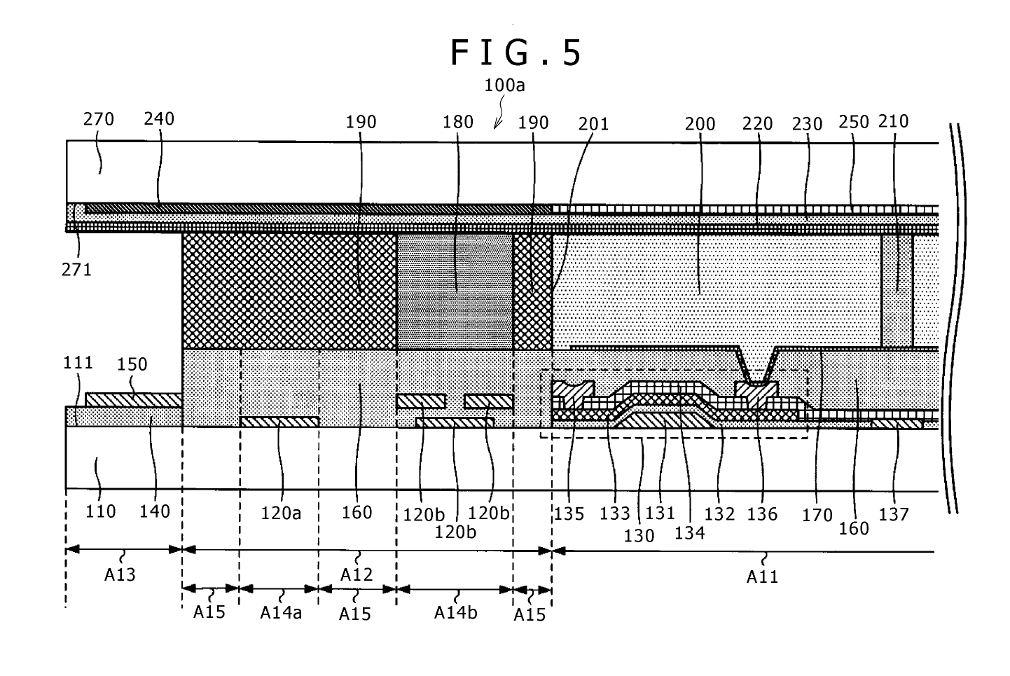

FIG. 5 is a sectional view showing the modification example of the liquid crystal display device according to the second embodiment.

In a liquid crystal display device 100a, the peripheral area A12 includes an interconnect pattern forming area A14a and an interconnect pattern forming area A14b having a width larger than that of the interconnect pattern forming area A14a. An interconnect pattern 120a is formed above the interconnect pattern forming area A14a, and an interconnect pattern 120b is formed above the interconnect pattern forming area A14b.

Above the peripheral area A12, the structural body 180 is so formed as to expose the interconnect pattern non-forming area A15 and the interconnect pattern 120a and cover the interconnect pattern 120b. The other configuration is the same as that of the liquid crystal display device 100.

That is, in the liquid crystal display device 100a, the structural body 180 is not formed above the interconnect pattern forming area A14a having a smaller width but formed above the interconnect pattern forming area A14b having a width larger than that of the interconnect pattern forming area A14a.

Due to this feature, in the liquid crystal display device 100a, the formation area of the seal material 190 can be increased corresponding to the interconnect pattern forming area A14a and thus adhesiveness to the insulating film 160 and the transparent electrode 220 can be enhanced.

It can be expected that the seal material 190 located above the interconnect pattern forming area A14a having a smaller width is irradiated with the light for curing the seal material 190, traveling around from the periphery of the interconnect pattern 120a. Thus, it is also possible to form the seal material 190 in a sufficiently-cured state.

Next, a method for manufacturing the liquid crystal display devices 100 and 100a will be described below as a third embodiment of the present invention.

### Third Embodiment

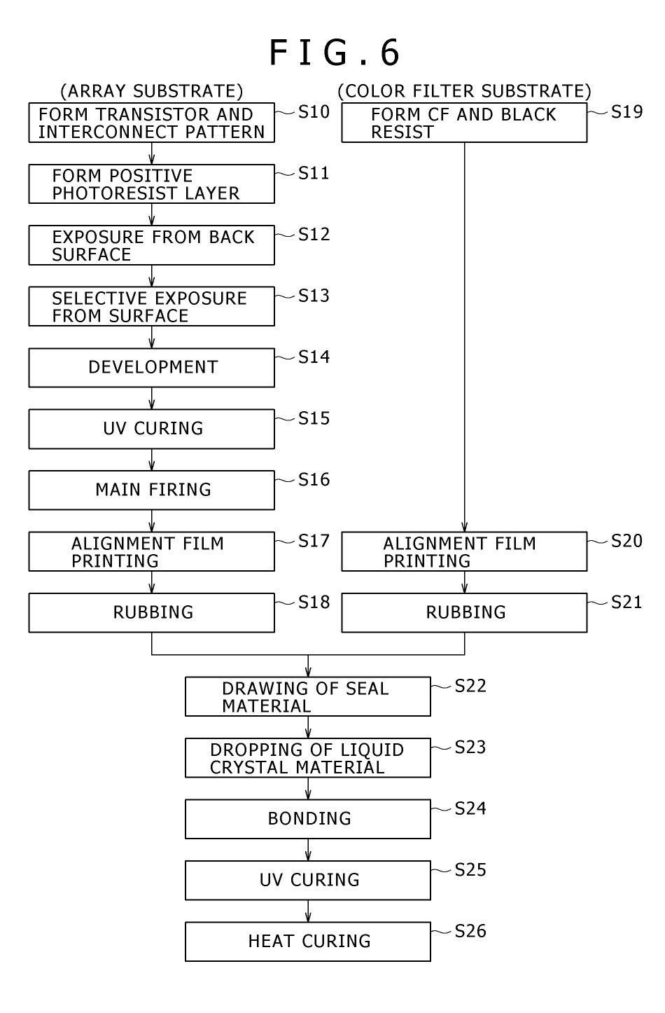

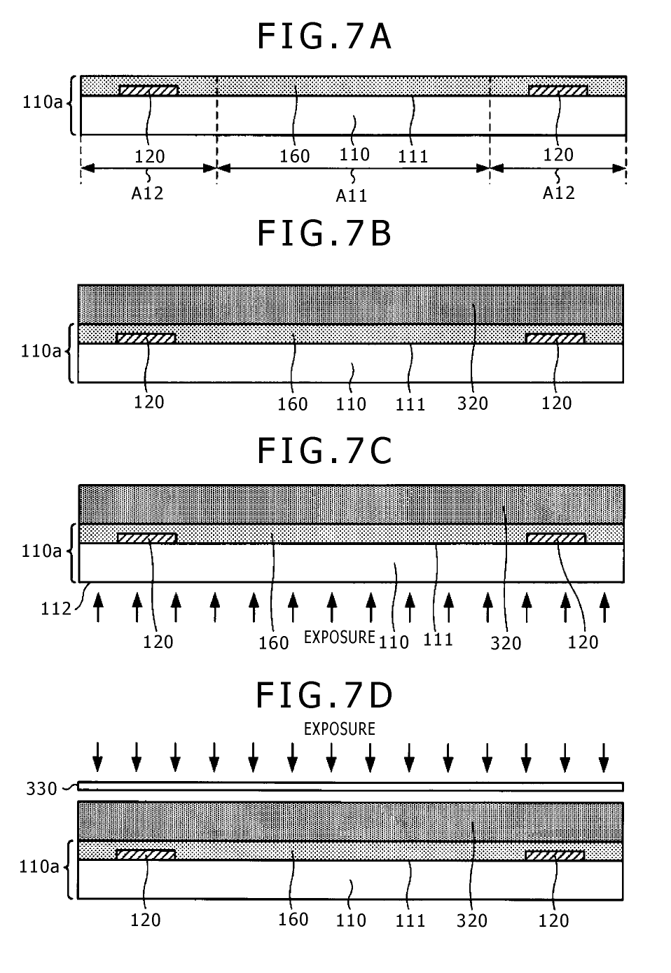

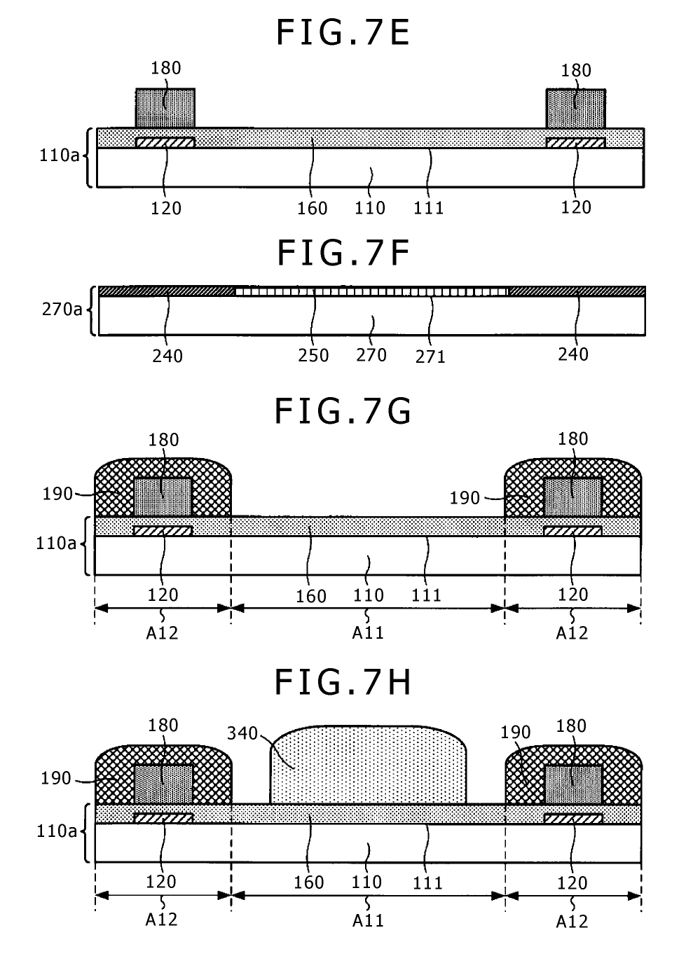

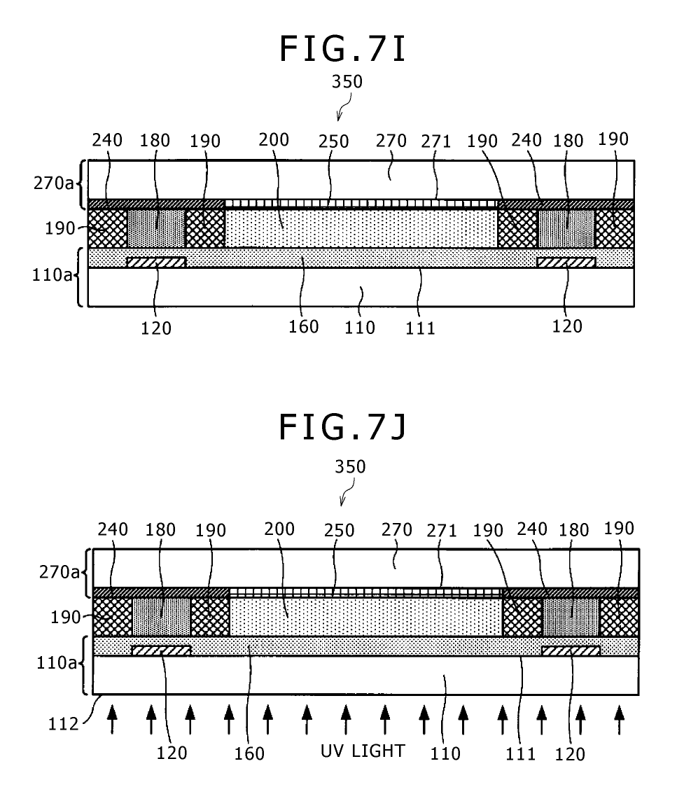

FIG. 6 is a flowchart showing one example of the method for manufacturing a liquid crystal display device according to the third embodiment. FIGS. 7A to 7J are step diagrams showing one example of the method for manufacturing a liquid crystal display device according to the third embodiment. The method for manufacturing a liquid crystal display device according to the third embodiment will be described below along the flowchart of FIG. 6 with use of the step diagrams of FIGS. 7A to 7J. In the description of the third embodiment, representative steps among all of the steps for manufacturing the liquid crystal display devices 100 and 100a will be explained.

First, a method for manufacturing the array substrate side will be described.

### [Step S10]

First, as shown in FIG. 7A, the interconnect pattern 120 (or the interconnect patterns 120a and 120b) and transistors (not shown) are formed over the surface 111 of the transparent substrate 110. The interconnect pattern 120 (or the interconnect patterns 120a and 120b) is formed above the peripheral area A12 and the transistors are formed above the display area A11.

Furthermore, over the surface 111 of the transparent substrate 110, the insulating film 160 is so formed as to cover the interconnect pattern 120 (or the interconnect patterns 120a and 120b) and the transistors. The resulting unit obtained by forming the interconnect pattern 120 (or the interconnect patterns 120a and 120b), the transistors, and the insulating film 160 over the surface 111 of the transparent substrate 110 will be referred to as an array substrate 110a.

### [Step S11]

Next, as shown in FIG. 7B, a positive photoresist layer 320 is formed over the array substrate 110a. The positive photoresist layer 320 is a resin containing e.g. a naphthoquinone diazide sulfonate ester compound as a photosensitizing agent. The positive photoresist layer 320 is formed e.g. by applying a liquid positive photoresist material over the array substrate 110a by using a spin-coating method.

### [Step S12]

Next, as shown in FIG. 7C, the array substrate 110a over which the positive photoresist layer 320 is formed is irradiated with light from the side of a back surface 112 of the transparent substrate 110 and the positive photoresist layer 320 is exposed. The exposure is performed e.g. by irradiation with light whose dominant wavelength is in the range of the wavelengths of the i-ray to the g-ray under such a condition that the exposure amount is 400 mJ/cm².

By this exposure, the positive photoresist layer 320 except the area above the interconnect pattern 120 (or the interconnect patterns 120a and 120b) is exposed. The partial area of the positive photoresist layer 320 located above the interconnect pattern 120 (or the interconnect patterns 120a and 120b) is not exposed because this partial area is shielded from the exposure light by the interconnect pattern 120 (or the interconnect patterns 120a and 120b). That is, the interconnect pattern 120 (or the interconnect patterns 120a and 120b) serves as the mask and the positive photoresist layer 320 is selectively exposed by self alignment.

### [Step S13]

Next, as shown in FIG. 7D, the array substrate 110a over which the positive photoresist layer 320 is formed is irradiated with light from the side of the surface 111 of the transparent substrate 110 via a mask 330 and the positive photoresist layer 320 is selectively exposed. The exposure is performed e.g. by irradiation with light whose dominant wavelength is in the range of the wavelengths of the i-ray to the g-ray under such a condition that the exposure amount is 200 mJ/cm². The exposure is performed by using exposure patterning apparatus capable of alignment, such as an aligner or stepper.

By this exposure, the partial area of the positive photoresist layer 320 that is not exposed in the exposure of the above-described step S12 due to the existence of a metal pattern other than the interconnect pattern 120 (or the interconnect patterns 120a and 120b) and the area where the positive photoresist layer 320 is not desired to be left finally are selectively exposed. For example, in this step, the positive photoresist layer 320 located above the lead-out interconnect 150 is exposed. Furthermore, for example in the method for manufacturing the liquid crystal display device 100a, the positive photoresist layer 320 located above the interconnect pattern 120a is exposed in this step.

It is also possible to interchange the step order between this step S13 and the above-described step S12. Alternatively, it is also possible to simultaneously carry out the step S13 and the step S12.

### [Step S14]

Next, as shown in FIG. 7E, the exposed positive photoresist layer 320 is developed. By the development, the positive photoresist layer 320 exposed by the exposure of the step S12 and the exposure of the step S13 is removed and the positive photoresist layer 320 located above the interconnect pattern 120 (or the interconnect pattern 120b) is selectively left to serve as the structural body 180.

Because the structural body 180 is formed in a self-aligned manner by use of the interconnect pattern 120 (or the interconnect pattern 120b) as the mask, it is disposed above the interconnect pattern 120 (or the interconnect pattern 120b) with high positional accuracy.

### [Step S15]

Next, UV curing is performed for the structural body 180. This makes it possible to suppress the deformation of the structural body 180 due to heat reflow in a post-baking step for the structural body 180. If the structural body 180 has a sufficiently-high glass transition temperature, the UV curing does not have to be performed.

### [Step S16]

Next, post-baking is performed for the structural body 180 to subject the structural body 180 to main firing.

### [Step S17]

Next, an alignment film (not shown) is formed over the array substrate 110a by printing.

### [Step S18]

Next, rubbing is performed for the alignment film formed over the array substrate 110a according to need.

Next, a method for manufacturing the color filter substrate side will be described below.

### [Step S19]

First, as shown in FIG. 7F, the color filter 250 and the black resist 240 are formed over the surface 271 of the transparent substrate 270. The resulting unit obtained by forming the color filter 250 and the black resist 240 over the surface 271 of the transparent substrate 270 will be referred to as a color filter substrate 270a.

### [Step S20]

Next, an alignment film (not shown) is formed over the color filter substrate 270a by printing.

### [Step S21]

Next, rubbing is performed for the alignment film formed over the color filter substrate 270a according to need.

Next, a step of stacking the array substrate 110a and the color filter substrate 270a will be described below.

### [Step S22]

First, as shown in FIG. 7G, the seal material 190 is supplied over the array substrate 110a. The seal material 190 is drawn above the peripheral area A12 of the transparent substrate 110 in such a manner as to cover the structural body 180. The seal material 190 may be supplied on the side of the color filter substrate 270a.

### [Step S23]

Next, as shown in FIG. 7H, a liquid crystal material 340 is supplied over the array substrate 110a to which the seal material 190 is supplied. The liquid crystal material 340 is supplied above the display area A11 of the transparent substrate 110. The liquid crystal material 340 is supplied by being dropped by use of a dispenser for example. The liquid crystal material 340 may be supplied on the side of the color filter substrate 270a.

### [Step S24]

Next, as shown in FIG. 7I, the color filter substrate 270a is stacked over the array substrate 110a with the intermediary of the structural body 180, the seal material 190, or the liquid crystal material 340, to form a stacked body 350. Specifically, the array substrate 110a and the color filter substrate 270a are bonded to each other by the seal material 190. The color filter substrate 270a is stacked over the array substrate 110a in such a manner that the surface 111 of the transparent substrate 110 and the surface 271 of the transparent substrate 270 are opposed to each other.

Due to the pressure occurring when the color filter substrate 270a is stacked over the array substrate 110a, the liquid crystal material 340 spreads in the space surrounded by the array substrate 110a, the color filter substrate 270a, and the seal material 190 and fills this space. Thereby, the liquid crystal layer 200 is formed. Moreover, due to the pressure occurring when the color filter substrate 270a is stacked over the array substrate 110a, the seal material 190 located over the structural body 180 is pushed out to the periphery of the structural body 180.

The liquid crystal material 340 may be supplied after the bonding of the array substrate 110a and the color filter substrate 270a to each other instead of being supplied in the above-described step S23. In this case, the liquid crystal material 340 is injected from the external into the space surrounded by the array substrate 110a, the color filter substrate 270a, and the seal material 190 e.g. via an opening provided in the seal material 190.

### [Step S25]

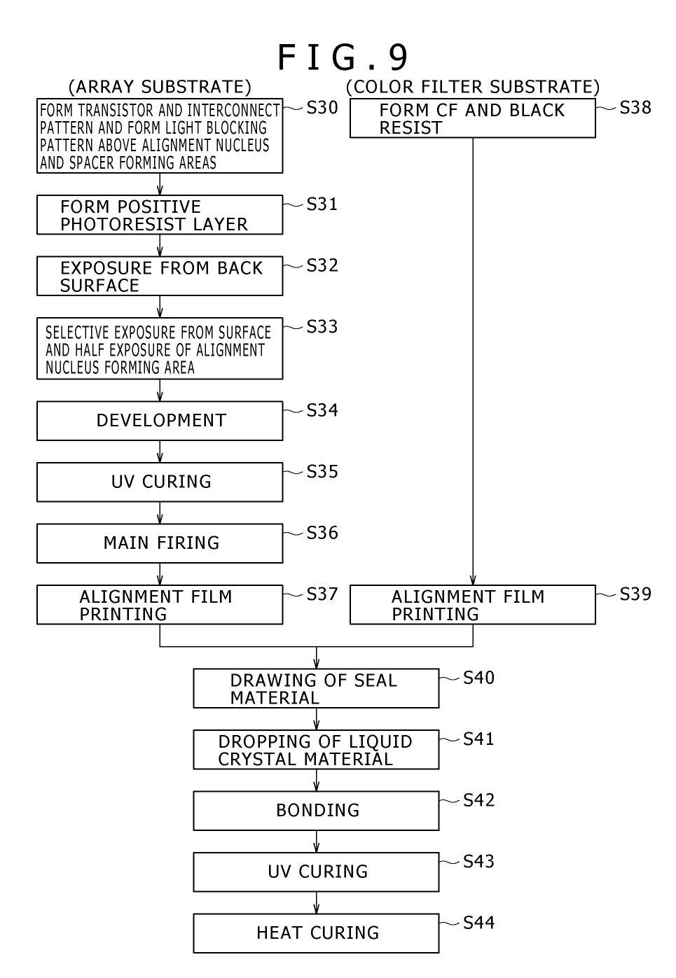

Next, as shown in FIG. 9J, the stacked body 350 is irradiated with UV light from the side of the back surface 112 of the transparent substrate 110 and the seal material 190 is cured.

### [Step S26]

Next, the stacked body 350 is heated to cure the liquid crystal layer 200.

In the above-described manner, the liquid crystal display devices 100 and 100a are manufactured.

As just described, in the third embodiment, the stacked body 350 in which the structural body 180 is formed above the interconnect pattern 120 is irradiated with light for curing the seal material 190 from the side of the back surface 112 of the transparent substrate 110. That is, at the place shielded from the light for curing the seal material 190 by the interconnect pattern 120, the structural body 180 is formed and the seal material 190 is not formed. This makes it possible to irradiate the whole area of the seal material 190 with the light and can sufficiently cure the seal material 190 across its whole area. Thus, the possibility of the elution of the seal material 190 into the liquid crystal layer 200 can be suppressed.

Furthermore, the arrangement and shape of the interconnect pattern 120 (or the interconnect patterns 120a and 120b) do not have to be changed, and therefore the flexibility of the design of the interconnect pattern 120 (or the interconnect patterns 120a and 120b) is also not limited.

Next, an embodiment in which an alignment nucleus is formed in the liquid crystal display device 100 will be described below as a fourth embodiment of the present invention.

### Fourth Embodiment

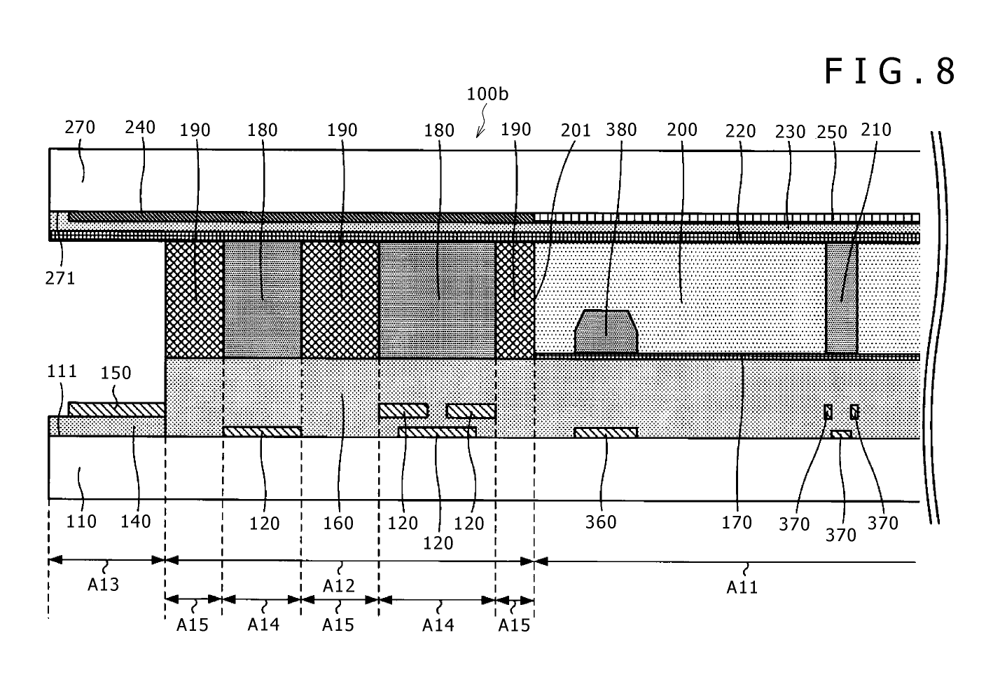

FIG. 8 is a sectional view showing one example of a liquid crystal display device according to the fourth embodiment.

A liquid crystal display device 100b has the following configuration in addition to the configuration of the liquid crystal display device 100.

In the liquid crystal display device 100b, light blocking patterns 360 and 370 having light blocking capability are formed above the display area A11. As the light blocking patterns 360 and 370, e.g. a metal pattern of molybdenum (Mo) is used. The insulating film 160 is so formed as to cover the light blocking patterns 360 and 370.

An alignment nucleus 380 is formed over the insulating film 160. The alignment nucleus 380 is formed above the light blocking pattern 360. The liquid crystal layer 200 is so formed as to cover the alignment nucleus 380. The alignment nucleus 380 controls the orientation of the liquid crystal layer 200. The spacer 210 is formed above the light blocking pattern 370.

Although one component is shown as each of the alignment nucleus 380 and the spacer 210 in the diagram, plural components may be formed as each of them. The same material as that of the structural body 180 is used for the alignment nucleus 380 and the spacer 210. In this configuration, a resist material such a resin is used as the material of the alignment nucleus 380 and the spacer 210.

As just described, in the liquid crystal display device 100b, the structural body 180, the alignment nucleus 380, and the spacer 210 are formed from the same material. This allows suppression of the material cost. Furthermore, similarly to the liquid crystal display device 100, the seal material 190 can be formed in a sufficiently-cured state and the possibility of the elution of the seal material 190 into the liquid crystal layer 200 can be suppressed.

Next, a method for manufacturing the liquid crystal display device 100b will be described below as a fifth embodiment of the present invention.

### Fifth Embodiment

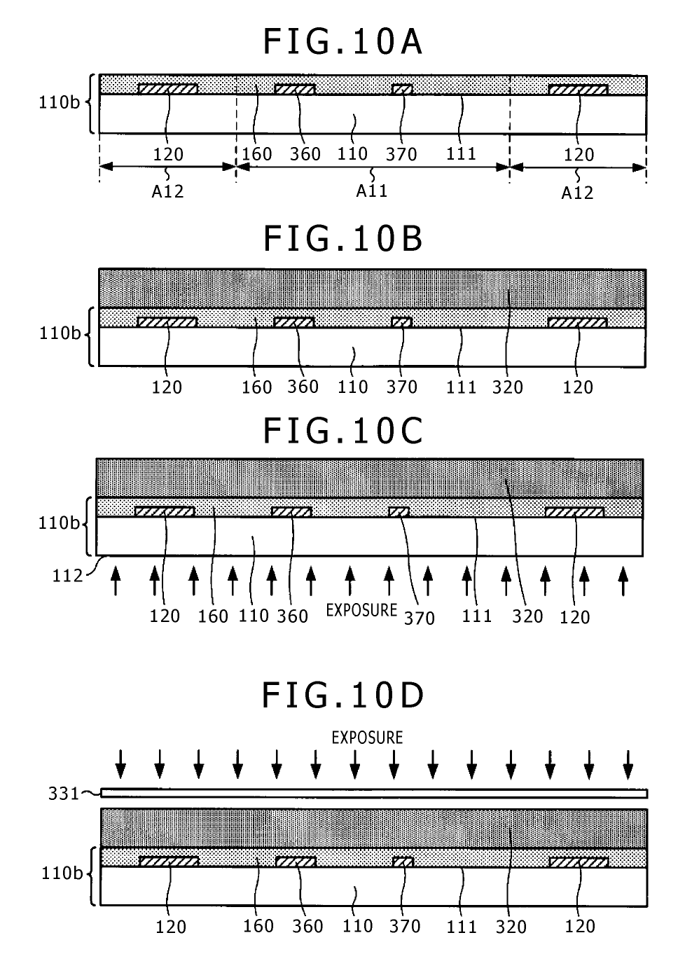

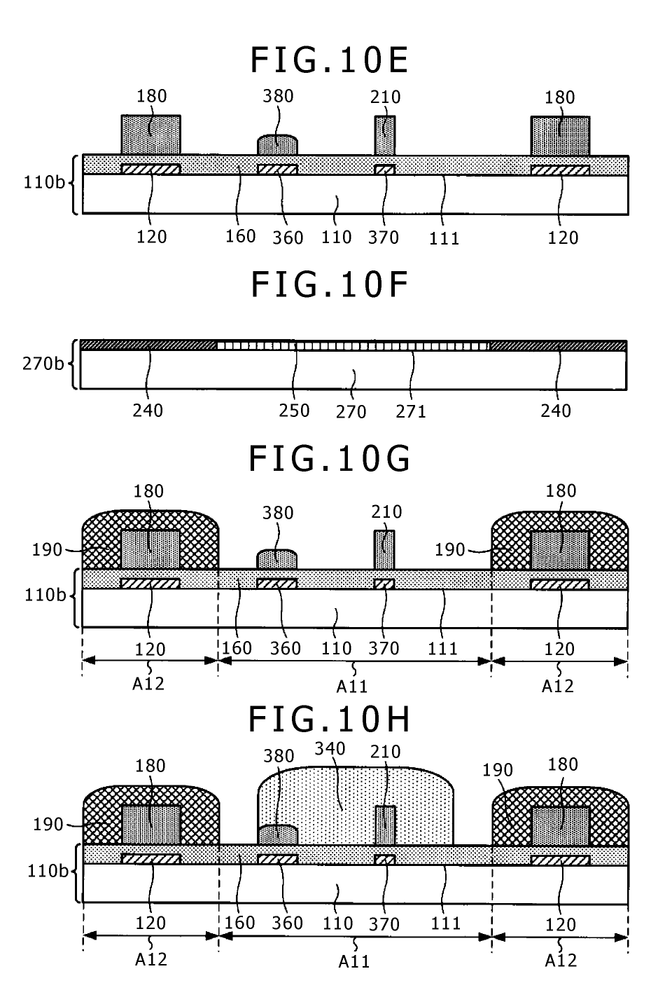

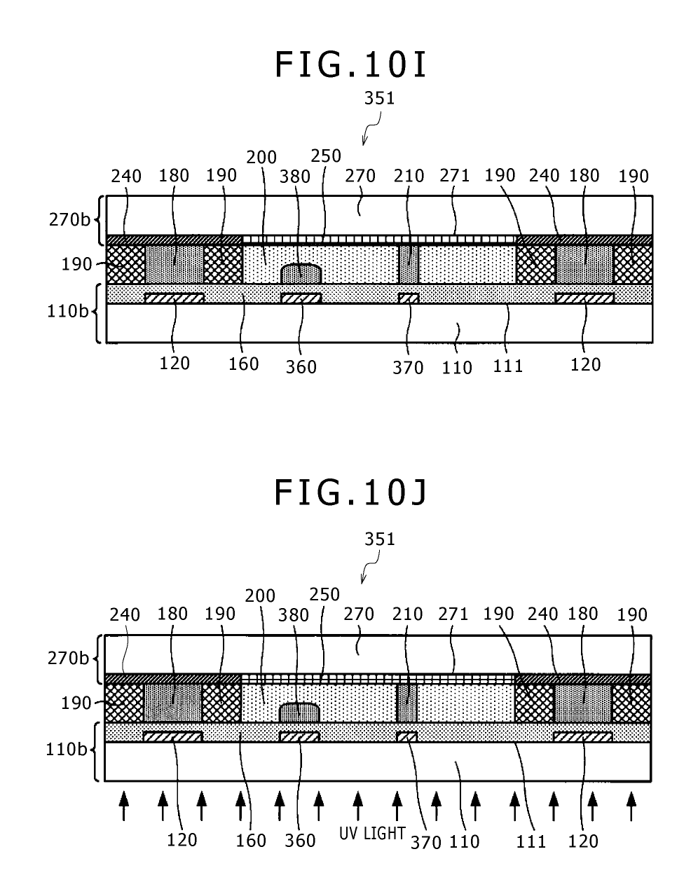

FIG. 9 is a flowchart showing one example of the method for manufacturing a liquid crystal display device according to the fifth embodiment. FIGS. 10A to 10J are step diagrams showing one example of the method for manufacturing a liquid crystal display device according to the fifth embodiment. The method for manufacturing a liquid crystal display device according to the fifth embodiment will be described below along the flowchart of FIG. 9 with use of the step diagrams of FIGS. 10A to 10J. In the description of the fifth embodiment, representative steps among all of the steps for manufacturing the liquid crystal display device 100b will be explained.

First, a method for manufacturing the array substrate side will be described.

### [Step S30]

First, as shown in FIG. 10A, the interconnect pattern 120, transistors (not shown), and the light blocking patterns 360 and 370 are formed over the surface 111 of the transparent substrate 110. The interconnect pattern 120 is formed above the peripheral area A12 and the transistors are formed above the display area A11. The light blocking pattern 360 is formed above an alignment nucleus forming area in the display area A11, and the light blocking pattern 370 is formed above a spacer forming area in the display area A11.

Furthermore, over the surface 111 of the transparent substrate 110, the insulating film 160 is so formed as to cover the interconnect pattern 120, the transistors, and the light blocking patterns 360 and 370. The resulting unit obtained by forming the interconnect pattern 120, the transistors, the light blocking patterns 360 and 370, and the insulating film 160 over the surface 111 of the transparent substrate 110 will be referred to as an array substrate 110b.

### [Step S31]

Next, as shown in FIG. 10B, the positive photoresist layer 320 is formed over the array substrate 110b. The positive photoresist layer 320 is formed e.g. by applying a liquid positive photoresist material over the array substrate 110b by using a spin-coating method.

### [Step S32]

Next, as shown in FIG. 10C, the array substrate 110b over which the positive photoresist layer 320 is formed is irradiated with light from the side of the back surface 112 of the transparent substrate 110 and the positive photoresist layer 320 is exposed. The exposure is performed e.g. by irradiation with light whose dominant wavelength is in the range of the wavelengths of the i-ray to the g-ray under such a condition that the exposure amount is 400 mJ/cm².

By this exposure, the positive photoresist layer 320 except the areas above the interconnect pattern 120 and the light blocking patterns 360 and 370 is exposed. The partial areas of the positive photoresist layer 320 located above the interconnect pattern 120 and the light blocking patterns 360 and 370 are not exposed because these partial areas are shielded from the exposure light by the interconnect pattern 120 and the light blocking patterns 360 and 370. That is, the interconnect pattern 120 and the light blocking patterns 360 and 370 serve as the mask and the positive photoresist layer 320 is selectively exposed by self alignment.

### [Step S33]

Next, as shown in FIG. 10D, the array substrate 110b over which the positive photoresist layer 320 is formed is irradiated with light from the side of the surface 111 of the transparent substrate 110 via a mask 331 and the positive photoresist layer 320 is selectively exposed. The exposure is performed e.g. by irradiation with light whose dominant wavelength is in the range of the wavelengths of the i-ray to the g-ray under such a condition that the exposure amount is 200 mJ/cm². The exposure is performed by using exposure pattering apparatus capable of alignment, such as an aligner or stepper.

By this exposure, the partial area of the positive photoresist layer 320 that is not exposed in the exposure of the above-described step S32 due to the existence of a metal pattern other than the interconnect pattern 120 and the light blocking patterns 360 and 370 and the area where the positive photoresist layer 320 is not desired to be left finally are selectively exposed. For example, in this step, the positive photoresist layer 320 located above the lead-out interconnect 150 is exposed.

Furthermore, at this time, half exposure is performed for the positive photoresist layer 320 located above the alignment nucleus forming area, i.e. above the light blocking pattern 360.

It is also possible to interchange the step order between this step S33 and the above-described step S32. Alternatively, it is also possible to simultaneously carry out the step S33 and the step S32.

### [Step S34]

Next, as shown in FIG. 10E, the exposed positive photoresist layer 320 is developed. By the development, the positive photoresist layer 320 exposed by the exposure of the step S32 and the exposure of the step S33 is removed and the positive photoresist layer 320 located above the interconnect pattern 120 is selectively left to serve as the structural body 180.

Furthermore, the positive photoresist layer 320 located above the light blocking pattern 360 is selectively left to serve as the alignment nucleus 380. In addition, the positive photoresist layer 320 located above the light blocking pattern 370 is selectively left to serve as the spacer 210. The height of the alignment nucleus 380 is lower than that of the structural body 180 and the spacer 210 because the positive photoresist layer 320 as its precursor is subjected to half exposure.

The structural body 180, the alignment nucleus 380, and the spacer 210 are formed in a self-aligned manner by use of the interconnect pattern 120 and the light blocking patterns 360 and 370 as the mask. Therefore, the structural body 180, the alignment nucleus 380, and the spacer 210 are disposed above the interconnect pattern 120 and the light blocking patterns 360 and 370 with high positional accuracy.

### [Step S35]

Next, UV curing is performed for the structural body 180, the alignment nucleus 380, and the spacer 210. This makes it possible to suppress the deformation of the structural body 180, the alignment nucleus 380, and the spacer 210 due to heat reflow in a post-baking step for them. If the structural body 180, the alignment nucleus 380, and the spacer 210 have a sufficiently-high glass transition temperature, the UV curing does not have to be performed.

### [Step S36]

Next, post-baking is performed for the structural body 180, the alignment nucleus 380, and the spacer 210 to subject the structural body 180, the alignment nucleus 380, and the spacer 210 to main firing.

### [Step S37]

Next, an alignment film (not shown) is formed over the array substrate 110b by printing.

Next, a method for manufacturing the color filter substrate side will be described below.

### [Step S38]

First, as shown in FIG. 10F, the color filter 250 and the black resist 240 are formed over the surface 271 of the transparent substrate 270. The resulting unit obtained by forming the color filter 250 and the black resist 240 over the surface 271 of the transparent substrate 270 will be referred to as a color filter substrate 270b.

### [Step S39]

Next, an alignment film (not shown) is formed over the color filter substrate 270b by printing.

Next, a step of stacking the array substrate 110b and the color filter substrate 270b will be described below.

### [Step S40]

First, as shown in FIG. 10G, the seal material 190 is supplied over the array substrate 110b. The seal material 190 is drawn above the peripheral area A12 of the transparent substrate 110 in such a manner as to cover the structural body 180. The seal material 190 may be supplied on the side of the color filter substrate 270b.

### [Step S41]

Next, as shown in FIG. 10H, the liquid crystal material 340 is supplied over the array substrate 110b to which the seal material 190 is supplied. The liquid crystal material 340 is supplied above the display area A11 of the transparent substrate 110. The liquid crystal material 340 is supplied by being dropped by use of a dispenser for example. The liquid crystal material 340 may be supplied on the side of the color filter substrate 270b.

### [Step S42]

Next, as shown in FIG. 10I, the color filter substrate 270b is stacked over the array substrate 110b with the intermediary of the structural body 180, the seal material 190, the spacer 210, and the liquid crystal material 340, to form a stacked body 351. Specifically, the array substrate 110b and the color filter substrate 270b are bonded to each other by the seal material 190.

The interval between the array substrate 110b and the color filter substrate 270b is kept by the spacer 210. The color filter substrate 270b is stacked over the array substrate 110b in such a manner that the surface 111 of the transparent substrate 110 and the surface 271 of the transparent substrate 270 are opposed to each other.

Furthermore, due to the pressure occurring when the color filter substrate 270b is stacked over the array substrate 110b, the liquid crystal material 340 spreads in the space surrounded by the array substrate 110b, the color filter substrate 270b, and the seal material 190 and fills this space. Thereby, the liquid crystal layer 200 is formed. Moreover, due to the pressure occurring when the color filter substrate 270b is stacked over the array substrate 110b, the seal material 190 located over the structural body 180 is pushed out to the periphery of the structural body 180.

The liquid crystal material 340 may be supplied after the bonding of the array substrate 110b and the color filter substrate 270b to each other instead of being supplied in the above-described step S41. In this case, the liquid crystal material 340 is injected from the external into the space surrounded by the array substrate 110a, the color filter substrate 270b, and the seal material 190 e.g. via an opening provided in the seal material 190.

### [Step S43]

Next, as shown in FIG. 10J, the stacked body 351 is irradiated with UV light from the side of the back surface 112 of the transparent substrate 110 and the seal material 190 is cured.

### [Step S44]

Next, the stacked body 351 is heated to cure the liquid crystal layer 200.

In the above-described manner, the liquid crystal display device 100b is manufactured.

As just described, in the fifth embodiment, the alignment nucleus 380 and the spacer 210 can be formed by using the back surface exposure and the development step for forming the structural body 180. This allows simplification of the steps for forming the alignment nucleus 380 and the spacer 210.

Furthermore, also in the fifth embodiment, similarly to the third embodiment, the whole area of the seal material 190 can be irradiated with light and the seal material 190 can be sufficiently cured across its whole area. Thus, the possibility of the elution of the seal material 190 into the liquid crystal layer 200 can be suppressed.

In addition, the arrangement and shape of the interconnect pattern 120 do not have to be changed, and therefore the flexibility of the design of the interconnect pattern 120 is also not limited.

The present application contains subject matter related to that disclosed in Japanese Priority Patent Application JP 2010-116916 filed in the Japan Patent Office on May 21, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a first transparent substrate configured to have a surface including a display area and a peripheral area that surrounds the display area and includes an interconnect pattern forming area and an interconnect pattern non-forming area;
an interconnect pattern configured to be formed above the interconnect pattern forming area and have light blocking capability;
a structural body configured to be formed above the peripheral area in such a manner as to expose the interconnect pattern non-forming area and cover the interconnect pattern;
a seal material configured to be formed above the peripheral area in such a manner as to cover the interconnect pattern non-forming area and surround the structural body;
a display layer configured to be formed above the display area; and
a second transparent substrate configured to be formed over the structural body, the seal material, and the display layer.

2. The display device according to claim 1, wherein
the peripheral area includes a first interconnect pattern forming area and a second interconnect pattern forming area having a width larger than width of the first interconnect pattern forming area,
a first interconnect pattern is formed above the first interconnect pattern forming area and a second interconnect pattern is formed above the second interconnect pattern forming area, and
the structural body is formed in such a manner as to expose the first interconnect pattern and cover the second interconnect pattern.

3. The display device according to claim 1, wherein
a light blocking layer is formed between the structural body and the seal material and the second transparent substrate.

4. The display device according to claim 1, wherein
a resist is used as a material of the structural body.

5. The display device according to claim 1, wherein
a liquid crystal layer is used as the display layer.

6. The display device according to claim 1, wherein
a resin having photocurability is used as the seal material.

7. A method for manufacturing a display device, the method comprising the steps of:
forming a positive photoresist layer over a surface side of a first transparent substrate that has a surface including a display area and a peripheral area surrounding the display area, an interconnect pattern having light blocking capability being formed above the peripheral area, the positive photoresist layer covering the peripheral area;
irradiating the first transparent substrate over which the positive photoresist layer is formed with light from a back surface side and exposing the positive photoresist layer by use of the interconnect pattern as a mask;
forming a structural body by developing the exposed positive photoresist layer and selectively leaving the positive photoresist layer located above the interconnect pattern;
forming a seal material surrounding the structural body above the peripheral area of the first transparent substrate over which the structural body is formed;
forming a stacked body obtained by stacking a second transparent substrate over the surface of the first transparent substrate with intermediary of the structural body and the seal material; and
irradiating the stacked body with light from the back surface side of the first transparent substrate and curing the seal material.

8. The method for manufacturing a display device according to claim 7, further comprising the step of
irradiating the first transparent substrate over which the positive photoresist layer is formed with light from the surface side via a mask and selectively exposing the positive photoresist layer.

9. The method for manufacturing a display device according to claim 7, wherein
a light blocking pattern having light blocking capability is formed above the display area,
the positive photoresist layer is formed in such a manner as to cover the peripheral area and the light blocking pattern, and
the structural body, a spacer and an alignment nucleus are formed by developing the exposed positive photoresist layer and selectively leaving the positive photoresist layer located above the interconnect pattern and the light blocking pattern.

10. The method for manufacturing a display device according to claim 9, further comprising the step of
performing half exposure of the positive photoresist layer located above the light blocking pattern.

11. The method for manufacturing a display device according to claim 7, further comprising the step of
forming a display layer above the display area, wherein
a liquid crystal layer is used as the display layer.

12. The method for manufacturing a display device according to claim 11, wherein
the liquid crystal layer is formed by dropping a liquid crystal material.

13. The method for manufacturing a display device according to claim 7, wherein
the light used for irradiation of the stacked body from the back surface side of the first transparent substrate is ultraviolet light.

14. The method for manufacturing a display device according to claim 7, wherein
a resin having photocurability is used as the seal material.
